(19) United States
(12) Patent Application Publication
(10) Pub. No.: US 2009/0322490 A1
(43) Pub. Date: Dec. 31, 2009

(54) RADIO FREQUENCY IDENTIFICATION MONITORING SYSTEM AND METHOD

(75) Inventors: Shao-Tsu KUNG, Taipei City (TW); Yi-Hung SHEN, Taipei City (TW); Jui-Tsen HUANG, Taipei City (TW); Cheng-Yi KO, Taipei City (TW)

Correspondence Address: Chih Feng Yeh;BRIAN M. MCINNIS, 12th Floor, Ruttonjee House, 11 Duddell Street, Hong Kong, HK

(73) Assignee: COMPAL ELECTRONICS, INC., Taipei City (TW)

(21) Appl. No.: 12/553,992

(22) Filed: Sep. 4, 2009

Related U.S. Application Data
(63) Continuation-in-part of application No. 11/226,229, filed on Sep. 15, 2005.

(30) Foreign Application Priority Data
Mar. 7, 2005 (TW) 94106851

(51) Int. Cl. H04Q 5/22

(52) U.S. Cl. 340/10.3; 340/10.31; 340/572.7

(57) ABSTRACT

The present invention provides a radio frequency identification (RFID) monitoring method, a reader located in a region to receive a tag ID code from a RFID tag, wherein the method comprises the steps of: (a) sending out a first reading signal from the reader; (b) determining whether the tag ID code is received by the reader; (c) recording a position of the RFID tag in a plane when the tag ID code is received by the reader; (d) rotating the reader a second angle toward a direction perpendicular to the plane; (e) sending out a second reading signal from the reader; (f) determining whether the tag ID code is received by the reader; and (g) recording a position of the RFID tag in the direction when the tag ID code is received by the reader.

### RELATED APPLICATIONS

This application is a continuation-in-part of U.S. application Ser. No. 11/226,229, filed Sep. 15, 2005, which is herein incorporated by reference.

### BACKGROUND

1. Field of Invention

The present invention relates to a radio frequency identification (RFID) system. More particularly, the present invention relates to an RFID monitoring system and method which can control the electrical power supplying of an RFID tag.

2. Description of Related Art

Radio frequency identification (RFID) is a non-contact automatic identification technique, which automatically identifies targets and obtains relative information by radio frequency signals, so as to have a fast and convenient process, omit manual operations during identifying and be able to identify plural tags and even dynamic targets simultaneously.

A complete RFID system comprises two parts, a reader and a transponder. The transponder is generally called an RFID tag. The operational principle of the RFID system is to transmit radio frequency energy of a certain frequency to the transponder for driving it to transmit its tag ID code, or alternatively, to transmit the tag ID code by the transponder itself. The reader receives the tag ID code and transmits it to a central system for carrying out relative data processes.

Because the electrical power for the RFID tag to transmit the tag ID code is converted from radio frequency energy transmitted by the reader, the RFID tag is called a passive RFID tag. The signal transmission range of the passive RFID tag is too short, and the signal intensity of the same is weak. Alternatively, a power supply can be configured in the RFID tag for continuously supplying electrical power to transmit the tag ID code. This RFID tag, which has a built-in power supply, is called an active RFID tag. The active RFID tag continuously transmits the tag ID code while it approaches the reader, and therefore it overly consumes electrical power such that its attached power supply can not support a long lifespan.

Modern RFID applications include logistics and supply management, manufacture and assemblage, airport baggage service, mail and express delivery, file tracking and library management, animal identification, access control, electrical entrance tickets and automatic fare collection. However, the so-called access control is only to obtain and identify the tag ID code of the RFID tag along with the user by the reader, without the function of tracking or recording the route of the user moving within a certain region.

### SUMMARY

It is therefore a objective of the present invention to provide a radio frequency identification (RFID) monitoring method to search a RFID tag in a region.

The present invention provides a radio frequency identification (RFID) monitoring method, a reader located in a region to receive a tag ID code from a RFID tag, wherein the method comprises the steps of: (a) sending out a first reading signal from the reader; (b) determining whether the tag ID code is received by the reader, wherein the RFID tag sends out the tag ID code when the RFID tag receives the first reading signal; (c) recording a position of the RFID tag in a plane when the tag ID code is received by the reader; (d) rotating the reader a second angle toward a direction perpendicular to the plane; (e) sending out a second reading signal from the reader; (f) determining whether the tag ID code is received by the reader, wherein the RFID tag sends out the tag ID code when the RFID tag receives the second reading signal; and (g) recording a position of the RFID tag in the direction when the tag ID code is received by the reader.

According to an embodiment, the RFID tag comprises: an antenna arranged to receive an enable signal or a disable signal; a control circuit electrically connected to the antenna; a power supply arranged to provide electrical power to the control circuit for transmitting a tag ID code through the antenna; and a lock circuit electrically connected to the power supply, wherein the lock circuit is arranged to enable and disable the power supply according to the enable signal and the disable signal, respectively.

### BRIEF DESCRIPTION OF THE DRAWINGS

These and other features, aspects, and advantages of the present invention will become better understood with regard to the following description, appended claims, and accompanying drawings where:

FIG. 1A is a schematic view of an RFID tag in a first preferred embodiment of the present invention;

FIG. 1B is a schematic view of an RFID monitoring system in the preferred embodiment of the present invention;

FIG. 1C is a schematic view of using a rotatable reader to identify the position of a RFID tag.

FIG. 1D is a schematic view of using a rotatable reader to identify the position of a RFID tag according to another embodiment of the present invention.

FIG. 1E is a schematic view of an antenna used in FIG. 1C and FIG. 1D.

FIG. 1F is a schematic view to illustrate the operation of the reader in a three-dimensions space.

FIG. 1G is a flow chart of the operation of the reader in a three-dimensions space.

FIG. 2 is a flow chart of the first preferred embodiment of the present invention;

FIG. 3 is a flow chart of a second preferred embodiment of the present invention; and

FIG. 4 is another flow chart of the second preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The present invention adds a lock circuit into an active RFID tag for controlling the switching of a power supply of the active RFID tag. By cooperating with an enable signal or a disable signal transmitted from a central controller through a reader, the monitoring capacity of the RFID system within a certain region is enhanced, and the power consumption of the active RFID tag is decreased, thus extending its battery life.

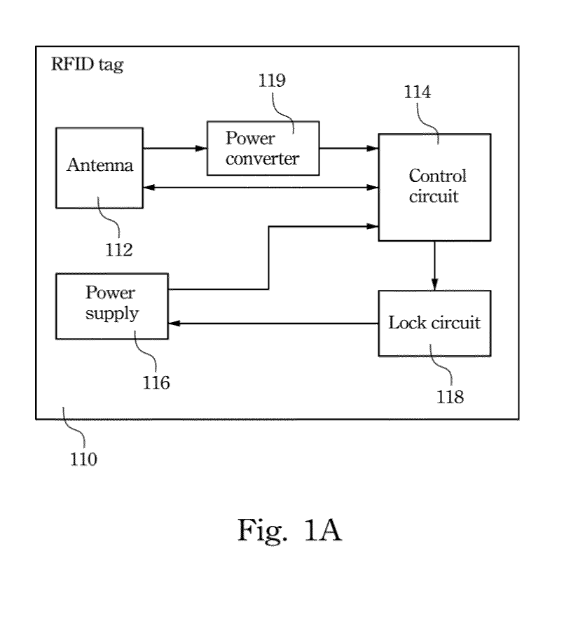

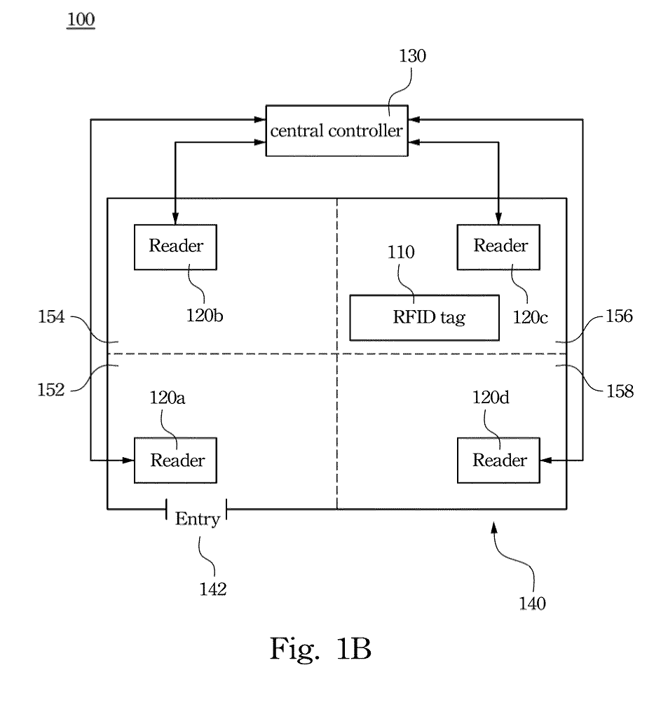

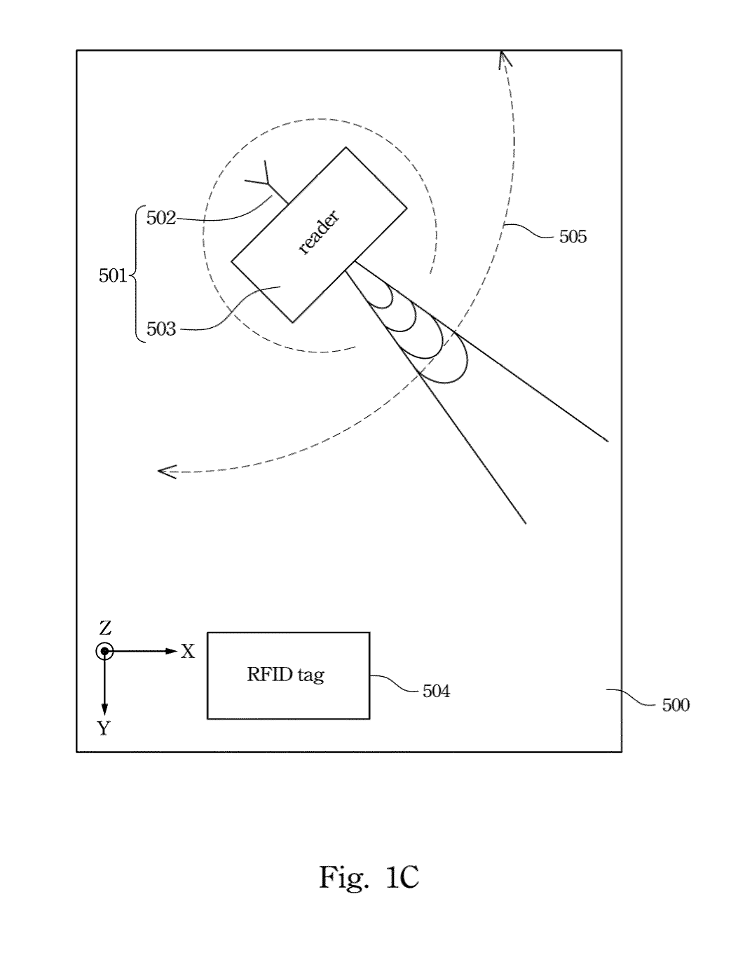

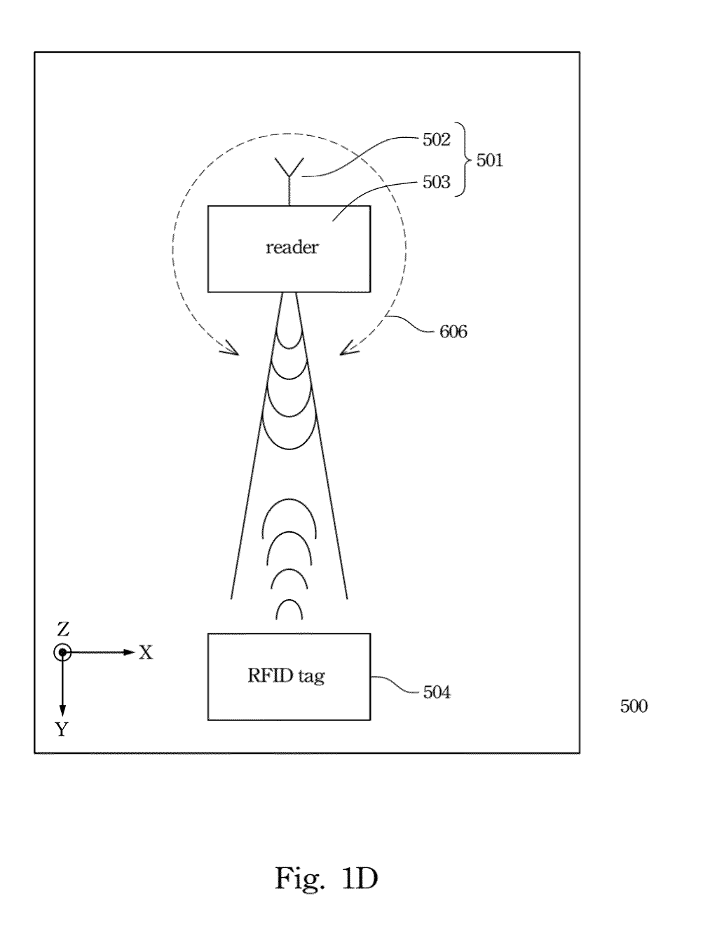

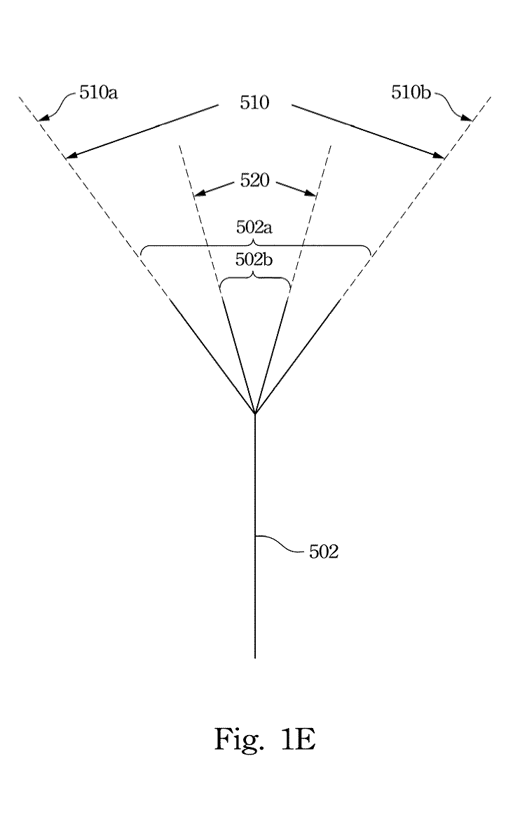

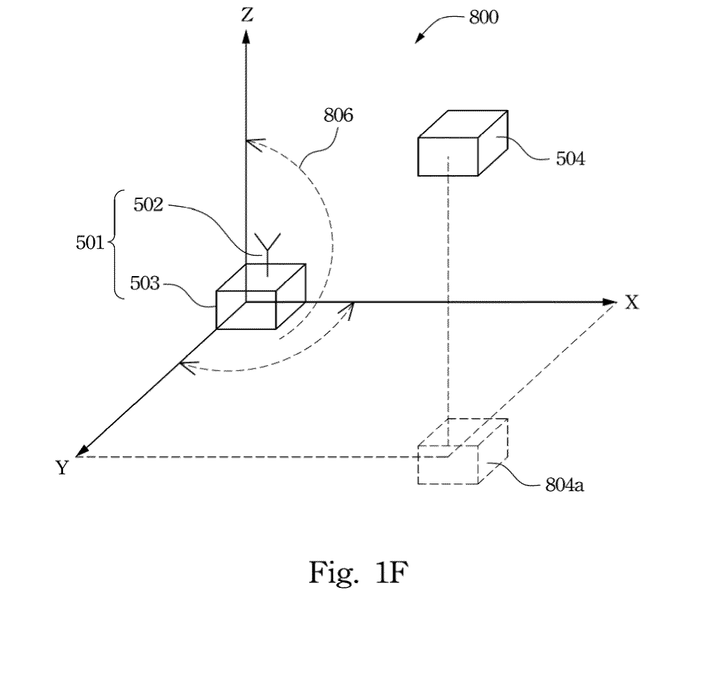

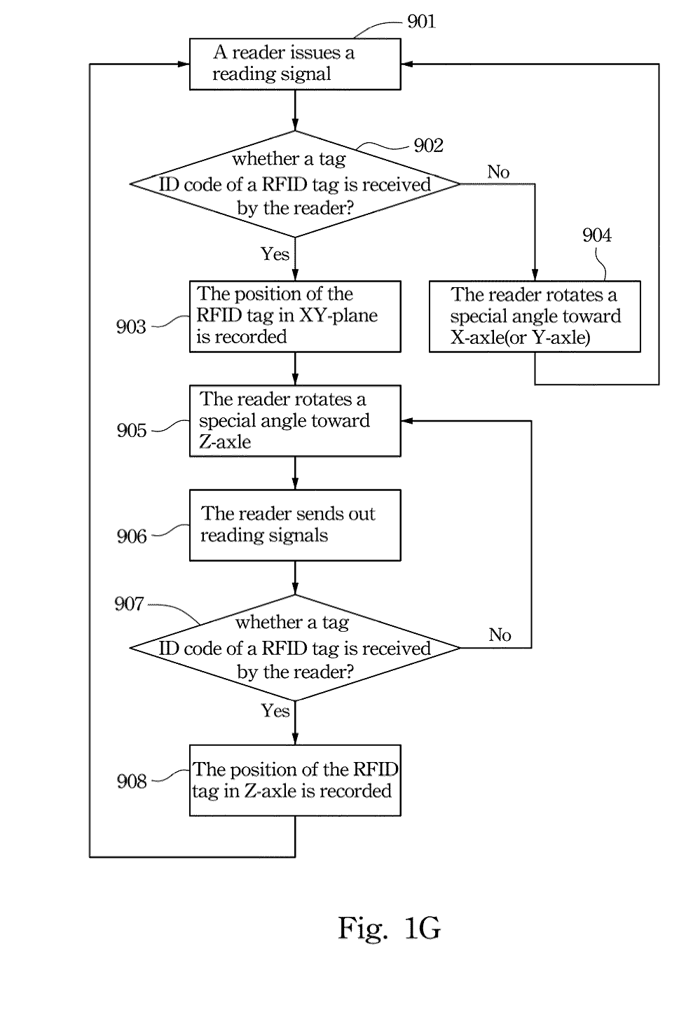

FIG. 1A is a schematic view of an RFID tag in a first preferred embodiment of the present invention. As illustrated in FIG. 1A, an RFID tag 110 comprises an antenna 112, a control circuit 114, a power supply 116 and a lock circuit 118. The antenna 112 is used to receive an enable signal or a disable signal. The control circuit 114 is electrically connected to the antenna 112 and stores a tag ID code. The power supply 116 supplies electrical power for the control circuit 114 to transmit the tag ID code through the antenna 112. The lock circuit 118 is electrically connected to the power supply 116 and enables and disables the power supply 116 according to the enable signal and the disable signal, respectively.

In the first preferred embodiment, after receiving the enable signal or the disable signal transmitted from the antenna 112, the control circuit 114 notifies the lock circuit 118 to enable or disable the power supply 116. Alternatively, the antenna can directly transmit the enable signal or the disable signal to the lock circuit 108. In addition, the control circuit 114 and the lock circuit 118 can be simultaneously integrated into a single controller.

Moreover, the RFID tag 110 further comprises a power converter 119. The power converter 119 converts a signal that is received by the antenna 112 into an electrical power for the control circuit 114 to transmit the tag ID code through the antenna 112. In other words, the RFID tag concurrently has the functions of the active RFID tag and the passive RFID tag. Furthermore, after the power supply 116 is enabled for a predetermined period, the lock circuit 118 automatically cuts off the power supplying of the power supply 116, thus improving the power saving of the RFID tag 110.

FIG. 1B is a schematic view of an RFID monitoring system in the preferred embodiment of the present invention. The following descriptions are made with references to FIG. 1A and FIG. 1B. As illustrated in FIG. 1A, the RFID monitoring system 100 comprises the RFID tag 110, a plurality of readers 120a, 120b, 120c and 120d, and a central controller 130. The readers 120a, 120b, 120c and 120d are disposed on different positions within a region 140 for receiving the tag ID code of the RFID tag 110 and determining whether the tag ID code is the same as an assigned ID code.

When the tag ID code is the same as the assigned code, one of the readers 120a, 120b, 120c and 120d, such as the one which is closest to the RFID tag 110, transmits an enable signal to enable the power supply 116 of the RFID tag 110. The central controller 130, such as a server or other suitable controller, identifies the position of the RFID tag 110 within the region 140 by receiving the tag ID code through the readers 120a, 120b, 120c and 120d. In this embodiment, four readers 120a, 120b, 120c and 120d are used to identify the position of the RFID tag. However, in another embodiment, the position of the RFID tag is identified by a rotatable reader only.

FIG. 1C is a schematic view of using a rotatable reader to identify the position of a RFID tag. The reader 501 is a rotatable reader. The reader 501 includes a reader body 503 and an antenna 502. A motor (not shown in this figure) is disposed in the bottom of the reader body 503 to rotate the reader. The antenna 502 issues a reading signal. When the RFID tag 504 receives the reading signal, the RFID tag 504 sends a tag ID code to the antenna 502 to inform the reader 501. Therefore, the reader 501 can know the RFID tag 504 is located in the region scanned by the reading signal.

In an embodiment, the reader 501 is located in a corner of the region 500 in FIG. 1C. The motor (not shown in the figure) is disposed in the bottom of the reader 501 to rotate the reader 501 in the plane. For example, the plane is determined by a X-axle and a Y-axle. The motor can rotate the reader 501 form Y-axle toward X-axle. Or, the motor can rotate the reader 501 form X-axle toward Y-axle. Arrow 505 indicates the rotation range. In this case, because the reader 501 is disposed in a corner of the region 500, the reader 501 only needs to rotate 90 degrees to scan the whole region 500 to search the RFID tag 504. For example, the reader 501 starts from the Y axle. At this time, the antenna 502 issues a reading signal to scan the region around the Y-axle. If the antenna 502 does not receive any information from the RFID tag 504 after a predetermined time period, such as 5 seconds, that means the RFID tag 504 does not locate in this region around the Y-axle, the motor rotates the reader 501 toward X-axle a predetermined angle, such as five degrees, to process a new search. In this embodiment, the motor rotates the reader 501 five degrees each time until the tag ID code of the RFID tag 504 is received by the reader 501. Then, the central controller 130 (shown in the FIG. 1B) identifies the position (XY plane) of the RFID tag 504 within the region 500 by receiving the tag ID code through the reader 501. After the position of the RFID tag 504 in the XY plane is identified, the motor can rotate the reader 501 toward the Z axle direction to search the position of the RFID tag 504 in the Z axle.

In another embodiment, the motor (not shown in the figure) is disposed in the bottom of the antenna 502 to only rotate the antenna 502 to scan the region 500. That is, the reader body 503 is fixed in a position. When a search is performed by the reader 501, only the antenna 502 is rotated to scan the region 500 to search the RFID tag 504. For example, the reader 501 starts from the Y axle. At this time, the antenna 502 issues a reading signal to scan the region around the Y-axle. If the antenna 502 does not receive any information from the RFID tag 504 after a predetermined time period, such as 5 seconds, that means the RFID tag 504 does not located in this region around the Y-axle, the motor rotates the antenna 502 toward X-axle a predetermined angle, such as five degrees, to process a new search. In this embodiment, the motor rotates the antenna 502 five degrees each time until the RFID tag 504 is identified in the XY plane. After the position of the RFID tag 504 in the XY plane is identified, the motor can rotate the antenna 502 toward the Z axle direction to search the position of the RFID tag 504 in the Z axle.

FIG. 1D is a schematic view of using a rotatable reader to identify the position of a RFID tag according to another embodiment of the present invention. In this embodiment, because the reader 501 is disposed in a central of the region 500, the reader 501 needs to rotate 360 degrees, indicated by the arrow 606, to scan the whole region 500 to search the RFID tag 504. The operation of reader 501 or antenna 502 for searching the RFID tag 504 is same as the operation described in the above embodiment.

FIG. 1E is a schematic view of an antenna used in FIG. 1C and FIG. 1D. The antenna aperture is the area presented to the radiated or received signal. In an embodiment, the antenna 502 has two different antenna aperture 502a and 502b to present different scan area to radiate reading signal. In another embodiment, the antenna 502 can have a plurality of antenna aperture. According to this embodiment, the antenna aperture 502a presents a scan area 510 and the antenna aperture 502b presents a scan area 520. When the antenna 502 starts to search the RFID tag 504, the antenna aperture 502a is set by the antenna 502 to presents a larger scan area, scan area 510, to process the start search. When the RFID tag 504 is found by the antenna 502, that means the RFID tag 504 is located in the scan area 510, the antenna aperture 502b is set by the antenna 502 to presents a smaller scan area, scan area 520, to process a further search to ensure the precise position of the RFID tag 504. In an embodiment, when the antenna aperture 502b is set by the antenna 50 to further search the RFID tag 504 locates in the scan area 510, the motor, no matter disposed in the bottom of the reader body 503 or the antenna 502, rotates the antenna 502 with antenna aperture 502b to scan the scan area 510. For example, the reader 501 starts from the side 510a. If the RFID tag 504 does not located in this region presented by the antenna aperture 502b, the motor rotates the antenna 502 a predetermined angle toward the side 510b to process a new search.

FIG. 1F is a schematic view to illustrate the operation of the reader in a three-dimensions space. In this embodiment, the reader 501 is located in a corner of the region 800 described by the X-axle, Y-axle and z-axle. The position of the RFID tag 504 in the XY plane is the position 804a. In the embodiment, the motor rotates the reader 501. The reader 501 starts from the Y axle. At this time, the antenna 502 issues a reading signal to scan the region around the Y-axle. If the antenna 502 does not receive any information from the RFID tag 504 after a predetermined time period, the motor rotates the reader 501 toward X-axle a predetermined angle. After the RFID tag 504 receives a reading signal radiated by the reader 501, the RFID tag 504 sends its tag ID code back to the antenna 502. Then, the central controller 130 (shown in the FIG. 1B) identifies the position, the position 804a, of the RFID tag 504 within the region 800 by receiving the tag ID code through the reader 501. After the position of the RFID tag 504 in the XY plane is identified, the motor rotates the reader 501 toward the Z axle direction, as indicated by arrow 806, to search the position of the RFID tag 504 in the Z axle. Similarly, the reader 501 starts from the XY plane. The motor rotates the reader 501 toward Z-axle a predetermined angle and the antenna 502 issues a reading signal to process a new search. When the RFID tag 504 receives a reading signal radiated by the reader 501 and sends its tag ID code back to the antenna 502. Then, the central controller 130 (shown in the FIG. 1B) identifies the position in the Z-axle of the RFID tag 504 within the region 800 by receiving the tag ID code through the reader 501.

FIG. 1G is a flow chart of the operation of the reader in a three-dimensions space. FIG. 1G and FIG. 1F are referred together.

In step 901, the antenna 502 of the reader 501 issues a reading signal to search the RFID tag 504. Next, a determining step is performed in step 902. The step 902 is to determine whether a tag ID code of the RFID tag 504 is received by the reader 501 or not. In an embodiment, when the RFID tag 504 receives the reading signal from the antenna 502 of the reader 501, the RFID tag 504 can send a tag ID code to the reader 501.

The step 904 and step 901 are performed when the antenna 502 of the reader 501 does not receive the tag ID code. In step 904, a motor rotates the reader 501 a special angle toward x-axle (or y-axle). Then, the antenna 502 of the reader 501 sends out a reading signal again in step 901 to process a new search.

On the other hand, the step 903 is performed when the antenna 502 of the reader 501 receives the tag ID code in step 902. In step 903, the position of the RFID tag in XY-plane is recorded when the reader receives the tag ID code. As shown in the FIG. 1F, after the RFID tag 504 receives a reading signal radiated by the reader 501, the RFID tag 504 sends its tag ID code back to the antenna 502. Then, the central controller 130 (shown in the FIG. 1B) identifies the position, the position 804a, of the RFID tag 504 within the region 800 by receiving the tag ID code through the reader 501.

Next, the reader rotates a special angle toward Z-axle in step 905 and sends out a reading signal in step 906. As shown in the FIG. 1G, after the position of the RFID tag 504 in the XY plane is identified, the motor rotates the reader 501 toward the Z axle direction, as indicated by arrow 806. Then, the antenna 502 issues a reading signal to search the position of the RFID tag 504 in the Z axle.

Then, a determining step is performed in step 907. The step is to determine whether a tag ID code is received by the reader or not. The step 905 and step 906 are performed again when the antenna 502 of the reader 501 does not receive the tag ID code. In step 905, a motor rotates the reader 501 a special angle toward z-axle. Then, the antenna 502 of the reader 501 sends out a reading signal again in step 906 to process a new search.

On the other hand, the step 908 is performed when the antenna 502 of the reader 501 receives the tag ID code in step 907. In step 908, the position of the RFID tag in z-axle is recorded when the reader receives the tag ID code. As shown in the FIG. 1F, when the RFID tag 504 receives a reading signal radiated by the reader 501 and sends its tag ID code back to the antenna 502. Then, the central controller 130 (shown in the FIG. 1B) identifies the position in the Z-axle of the RFID tag 504 within the region 800 by receiving the tag ID code through the reader 501.

Finally, the flow chard is performed again when another RFID tag into the region 800.

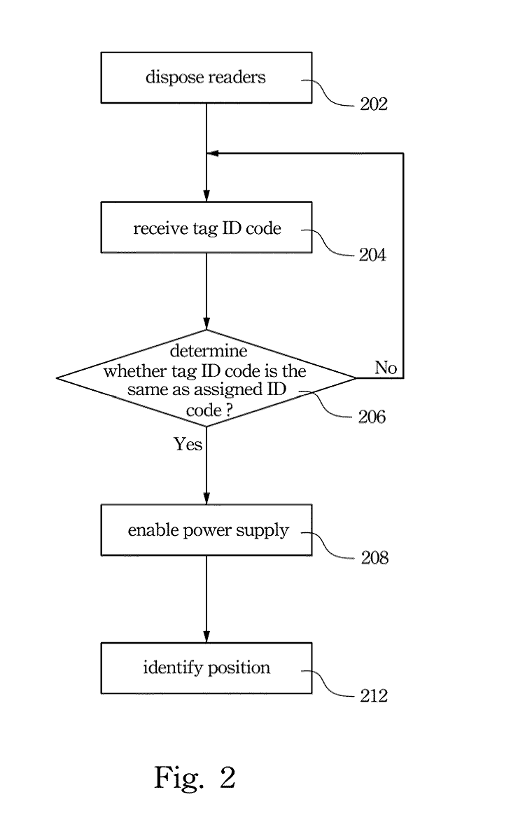

FIG. 2 is a flow chart of the first preferred embodiment of the present invention, illustrating the RFID monitoring method of the present invention. For clarity, the following descriptions are made with references to FIG. 1A, FIG. 1B and FIG. 2. However, in another embodiment, a rotatable reader 501 as shown in FIG. 1C can be also used in the following embodiments.

The preferred embodiment firstly configures the readers 120a, 120b, 120c and 120d on different positions within the region 140 for receiving the tag ID code of the RFID tag 110 (step 202). When one of the readers 120a, 120b, 120c and 120d receives the tag ID code (step 204), the tag ID code is compared to an assigned ID code, determining whether the tag ID code is the same as the assigned ID code (step 206). When the tag ID code is the same as the assigned ID code, the power supply 116 is enabled to provide electrical power for repeatedly sending the tag ID code (step 208). Then, the position of the RFID tag 110 within the region 140 is identified by receiving the tag ID code through the readers 120a, 120b, 120c and 120d (step 212).

Generally, the reader has a preferred available region due to the distance limitation of radio frequency transmission. As illustrated in FIG. 1B, each of the readers 120a, 120b, 120c and 120d are separately in charge of receiving radio frequency signals within each subregions 152, 154, 156 and 158, respectively. The central controller 130 can identify which subregions 152, 154, 156 and 158 the RFID tag 110 is positioned in by these corresponding readers 120a, 120b, 120c and 120d that are in charge of different subregions.

For example, when a plurality of RFID tags 110 exist in the region 140, a wanted RFID tag 110 can be firstly assigned. When the wanted RFID tag 110 approaches one of the readers 120a, 120b, 120c and 120d, the power supply 116 of the RFID tag 110 is enabled to make the RFID tag 110 continuously transmit its tag ID code. Moreover, because the power supply 116 generally supplies a greater amount of electrical power than that induced by the power converter 119, the tag ID code therefore can be transmitted to a farther distance by electrical power provided from the power supply 116, thus increasing the possibility of successfully detecting the tag ID code by the readers 120a, 120b, 120c and 120d.

The RFID tag can be disposed on a movable object, such as a user, a portable electronic device, a book, or other object that may be taken by a user and moved along with the user. Therefore, with continuously detecting the tag ID code by the readers 120a, 120b, 120c and 120d that are separately in charge of different subregions 152, 154, 156 and 158, a real-time position of the wanted RFID tag 110 within the region 140 can be instantly identified.

Moreover, the different spatial positions of the readers and the different transmission ranges of the RFID tag can be further used to estimate a more precise position of the RFID tag 110. As mentioned above, the transmission range of the tag ID code can be adjusted by the different amounts of electrical power supplied for transmitting the tag ID code. For example, the transmission region of the tag ID code can be adjusted by different amounts of electrical power from the power supply 116 and the power converter 119, or by different amounts of electrical power supplied from the power supply 116 due to different enable signals.

According to the second preferred embodiment of the present invention, the readers 120a, 120b, 120c and 120d can be suitably disposed spatially within the region 140. The central controller 130 uses the spatial distribution of the readers 120a, 120b, 120c and 120d and the different amounts of power supplying to estimate a more precise position of the RFID tag 110 within the region 140 according to the corresponding variations of which readers can receive the tag ID code under the different amounts of power supplying.

In another aspect, the coverage of each of the subregions 152, 154, 156 and 158 is respectively determined by the signal transmission capacity of each of the readers 120a, 120b, 120c and 120d. Therefore, the coverage of each subregion 152, 154, 156 or 158 can be substantially enlarged by properly adjusting the power and the radio frequency of the corresponding reader. In addition to distributing the readers in a region with an arrangement, such as in a cellular distribution, the RFID monitoring system 100 can be used to monitor the RFID tags within an extensive region, such as within a town or a science park having many factories, rather than only within a restricted area or a single factory.

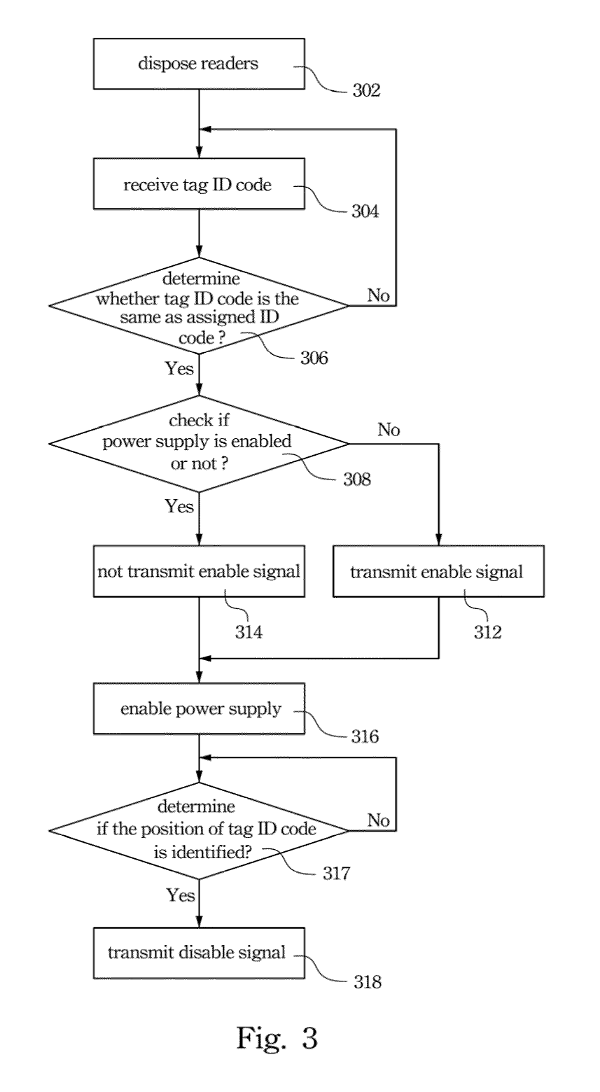

FIG. 3 is a flow chart of a second preferred embodiment of the present invention. Compared to the preferred embodiment as illustrated in FIG. 2, the preferred embodiment has additional steps of disabling the power supply after the position of the RFID tag is identified and determining whether or not the power supply is enabled. The preferred embodiment can increase the power efficiency of the active RFID tag, extending its battery life.

For clarity, the following descriptions are made with references to FIG. 1A, FIG. 1B and FIG. 3. The preferred embodiment firstly configures the readers 120a, 120b, 120c and 120d on different positions within the region 140 for receiving the tag ID code of the RFID tag 110 (step 302). When one of the readers 120a, 120b, 120c and 120d receives the tag ID code (step 304), the tag ID code is compared to an assigned ID code, determining whether the tag ID code is the same as the assigned ID code (step 306). When the tag ID code is the same as the assigned ID code, the power supply 116 is checked to determine whether it is enabled or not (step 308).

When the power supply 116 is not enabled, an enable signal is transmitted to the RFID tag 110, making the lock circuit 118 enable the power supply 116 to provide electrical power (step 312). When the power supply 116 is enabled, the enable signal is not transmitted (step 314). The position of the RFID tag 110 within the region 140 is identified by receiving the tag ID code through the readers 120a, 120b, 120c and 120d (step 316). Whether the position of the tag ID code (i.e. the RFID tag 110) within the region 140 is identified or not is then determined (step 317). When the position of the RFID tag 110 within the region 140 is identified, a disable signal is transmitted to the RFID tag 110 to make the lock circuit 118 disable the power supply 116 from providing electrical power, saving the power consumption of the power supply 116 (step 318).

The determining step 317 can be based on time; for example, the position of the identified RFID tag 110 can be directly decided after transmitting the enable signal for a few minutes, or after the RFID tag 110 has remained on or around a certain position for a period. Alternatively, this determining step 317 can use other criteria, such as an indication from the system administrator or from the user to whom the RFID tag belongs. The preferred embodiment does not limit the determining manner, and any other manners suitable for different situations should be included in the scope of the present invention.

More precisely, when an object on which the RFID tag 110 is configured has stopped moving or stayed in one of the subregions 152, 154, 156 and 158 for a period, or the object configuring the RFID tag 110 has passed by or entered into one of the subregions 152, 154, 156 and 158, or the system administrator believes the monitoring is completed, the enable can be transmitted to disable the power supply 116 from unnecessary power consumption.

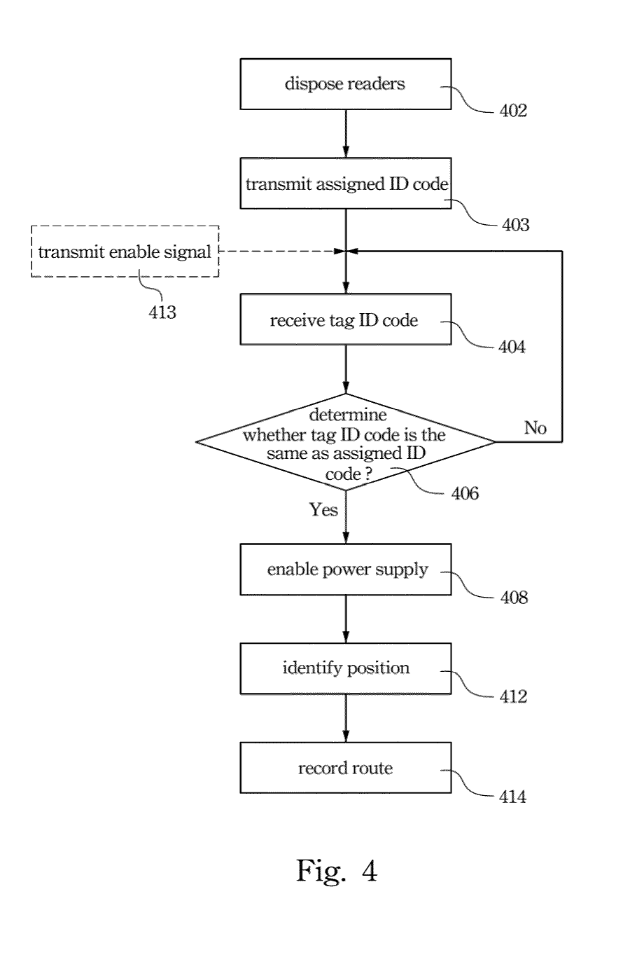

FIG. 4 is another flow chart of the second preferred embodiment of the present invention. Compared to the preferred embodiment as illustrated in FIG. 2, the preferred embodiment has additional steps of setting the assigned ID code and recording the route of the RFID tag moving within the region. Furthermore, the preferred embodiment can transmit the enable signal to enable the power supply when the RFID tag initially enters the region. Therefore, the second preferred embodiment further illustrates different applications of the RFID monitoring method and system of the present invention.

For clarity, the following descriptions are made with references to FIG. 1A, FIG. 1B and FIG. 4. The second preferred embodiment firstly configures the readers 120a, 120b, 120c and 120d on different positions within the region 140 for receiving the tag ID code of the RFID tag 110 (step 402). Moreover, the central controller 130 sets the assigned ID code and transmits the assigned ID code to the readers 120a, 120b, 120c and 120d (step 403).

The system administrator preferably sets or changes the assigned ID code by the central controller 130, thus enhancing the management flexibility of the RFID monitoring system. However, persons skilled in the art should understand that other manners for setting the assigned ID code, such as separately inputting into each reader or recording in the readers in advance, also fall within the scope of the present invention.

When one of the readers 120a, 120b, 120c and 120d receives the tag ID code (step 404), the tag ID code is compared to an assigned ID code, determining whether the tag ID code is the same as the assigned ID code (step 406). When the tag ID code is the same as the assigned ID code, the power supply 116 is enabled to provide electrical power for repeatedly sending the tag ID code (step 408). Then, the position of the RFID tag 110 within the region 140 is identified by receiving the tag ID code through the readers 120a, 120b, 120c and 120d (step 412). Moreover, the central controller 130 can identify the route of the RFID tag 110 moving within the region 140 by continuously receiving the tag ID code through the readers 120a, 120b, 120c and 120d (step 414).

In addition, in order to achieve the objectives of automatic recording, tracking or controlling, the enable signal can be transmitted to enable the power supply 116 for providing electrical power when the RFID tag 110 initially enters the region 140 (step 413). For example, the reader 120a, which is closest to an entry 142 of the region 140, is used to be an initial reader, which instantly transmits the enable signal to enable the power supply 116 when any RFID tag 110 enters the region 140 through the entry 142. The central controller 130 is ensured to fully record and track the position or route of every RFID tag 110 within the region 140.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A radio frequency identification (RFID) tag position identifying method for a reader, wherein the reader issues a reading signal, comprising:
scanning a first plane by the reader to determine whether a tag ID code is received by the reader, wherein the RFID tag sends out the tag ID code when the RFID tag receives the reading signal;
identifying a first position of the RFID tag in the first plane when the tag ID code is received by the reader;
scanning a second plane from the first position by the reader, wherein the second plane is perpendicular to the first plane; and
identifying a second position of the RFID tag in the second plane when the tag ID code is received by the reader, wherein the first position and the second position define the RFID tag position.

2. The method as claimed in claim 1, wherein scanning a first plane by the reader further comprises:
sending out a reading signal from the reader, wherein the reader is located in a first axle;
determining whether the tag ID code is received by the reader, wherein the RFID tag sends out the tag ID code when the RFID tag receives the reading signal; and
rotating a first angle toward a second axle by the reader and sending out the reading signal from the reader when the tag ID code is not received by the reader, wherein the first axle and the second axle define the first plane.

3. The method as claimed in claim 1, wherein scanning a second plane from the first position by the reader further comprises:
rotating a second angle toward a third axle by the reader, wherein the third axle is perpendicular to the second plane and the third axle and the first position define the second plane;
sending out the reading signal from the reader;
determining whether the tag ID code is received by the reader;
rotating a second angle toward the third axle by the reader and sending out the reading signal from the reader when the tag ID code is not received by the reader.

4. The method as claimed in claim 1, wherein the reader has an antenna to issue the reading signal.

5. The method as claimed in claim 4, wherein the antenna has at least two antenna apertures, a first antenna aperture and a second antenna aperture, the first antenna aperture defines a first scan area and the second antenna aperture defines a second scan area, the first scan area is larger than the second scan area.

6. The method as claimed in claim 5, wherein scanning a first plane by the reader further comprises:
scanning the first plane by the reader to determine whether a tag ID code is received by the reader, wherein the antenna of the reader has the first antenna aperture;
identifying a region of the RFID tag in the first plane when the tag ID code is received by the antenna, wherein an area of the region is equal to the first scan area;
scanning the region by the reader, wherein the antenna of the reader has the second antenna aperture; and
identifying a position of the RFID tag in the region when the tag ID code is received by the reader, wherein the region and the position define the first position of the RFID tag.

7. The method as claimed in claim 5, wherein scanning a second plane by the reader further comprises:
scanning the second plane by the reader to determine whether a tag ID code is received by the reader, wherein the antenna of the reader has the first antenna aperture;
identifying a region of the RFID tag in the second plane when the tag ID code is received by the antenna, wherein an area of the region is equal to the first scan area;
scanning the region by the reader, wherein the antenna of the reader has the second antenna aperture; and
identifying a position of the RFID tag in the region when the tag ID code is received by the reader, wherein the region and the position define the second position of the RFID tag.

8. A radio frequency identification (RFID) tag position identifying method for a reader, wherein the reader is located in a first axle to receive a tag ID code from the RFID tag, wherein the method comprises the steps of:
sending out a reading signal from the reader;
determining whether the tag ID code is received by the reader, wherein the RFID tag sends out the tag ID code when the RFID tag receives the reading signal;
rotating a first angle toward a second axle by the reader and sending out the reading signal from the reader when the tag ID code is not received by the reader, wherein the first axle and the second axle define a plane;
identifying a first position of the RFID tag in the plane when the tag ID code is received by the reader; rotating a second angle toward a third axle by the reader, wherein the third axle is perpendicular to the plane;
sending out the reading signal from the reader;
determining whether the tag ID code is received by the reader;
rotating a second angle toward the third axle by the reader and sending out the reading signal from the reader when the tag ID code is not received by the reader; and
identifying a second position of the RFID tag in the third axle when the tag ID code is received by the reader, wherein the first position and the second position define the RFID tag position.

9. The method as claimed in claim 8, wherein the reader has an antenna to issue the reading signal.

10. The method as claimed in claim 9, wherein the antenna has at least two antenna apertures, a first antenna aperture and a second antenna aperture, the first antenna aperture defines a first scan area and the second antenna aperture defines a second scan area, the first scan area is larger than the second scan area.

11. The method as claimed in claim 10, wherein rotating a first angle toward a second axle by the reader further comprises:
determining whether a tag ID code is received by the reader, wherein the antenna of the reader has the first antenna aperture;
identifying a region of the RFID tag in the plane when the tag ID code is received by the antenna, wherein an area of the region is equal to the first scan area;
scanning the region by the reader, wherein the antenna of the reader has the second antenna aperture; and
identifying a position of the RFID tag in the region when the tag ID code is received by the reader, wherein the region and the position define the first position of the RFID tag.

12. The method as claimed in claim 10, wherein rotating a second angle toward the third axle by the reader further comprises:
determining whether a tag ID code is received by the reader, wherein the antenna of the reader has the first antenna aperture;
identifying a region of the RFID tag in a second plane that is defined by the first position and the third axle when the tag ID code is received by the antenna, wherein the area of the region is equal to the first scan area;
scanning the region by the reader, wherein the antenna of the reader has the second antenna aperture; and
identifying a position of the RFID tag in the region when the tag ID code is received by the reader, wherein the region and the position define the second position of the RFID tag.

13. The method as claimed in claim 8, wherein the reader has an antenna, wherein rotating the reader is to rotate the antenna.
